(19) United States
(12) Patent Application Publication
(10) Pub. No.: US 2011/0038045 A1
(43) Pub. Date: Feb. 17, 2011

(54) NEAR-ZERO OPTICAL RETARDATION FILM

(76) Inventors: Weijun Zhou, Lake Jackson, TX (US); Stephen F. Hahn, Midland, MI (US); Charles F. Diehl, Lake Jackson, TX (US); Kurt A. Koppi, Midland, MI (US)

Correspondence Address: The Dow Chemical Company, P.O. BOX 1967, 2040 Dow Center, Midland, MI, 48641, US

(21) Appl. No.: 12/989,565

(22) PCT Filed: Apr. 24, 2009
(86) PCT No.: PCT/US2009/041650

§ 371 Date: Oct. 25, 2010

Related U.S. Application Data
(60) Provisional application No. 61/051,160, filed on May 7, 2008.

(51) Int. Cl. G02B 5/30; C09K 19/02; C09K 19/52; C08L 9/00

(52) U.S. Cl. 359/485; 428/1.55; 525/232

(57) ABSTRACT

An optical film, suitable or use in, or as a component of, an image display device or apparatus (for example, a LCD device or a polarizer assembly), comprises a hydrogenated vinyl aromatic/conjugated diene block copolymer that has a near zero optical retardation at all light incidence angles (measured using incident light at a wavelength of 633 nanometers).

This application is a non-provisional application claiming priority from the U.S. Provisional Patent Application No. 61/051,160, filed on May 7, 2008, entitled “NEAR-ZERO OPTICAL RETARDATION FILM,” the teachings of which are incorporated by reference herein, as if reproduced in full hereinbelow.

This invention relates generally to a polymeric film, especially a polymeric film that comprises a hydrogenated block copolymer, preferably a substantially hydrogenated block copolymer and even more preferably a fully hydrogenated block copolymer, wherein the block copolymer prior to hydrogenation is a copolymer of a vinyl aromatic monomer and a diene (for example, a conjugated diene such as 1,3-butadiene, isoprene or a mixture thereof). This invention relates more particularly to such films that have a very low (near zero nanometer (nm)) optical retardation in both film plane and thickness direction, denoted as R₀ and Rth, respectively. This invention also relates to use of such optical films, whether stretched (oriented) or unstretched (unoriented), in various end use applications including, but not limited to, color improvement and viewing angle enhancement of a liquid crystal display (LCD) television (TV) set or as an optical element of some other display device.

Manufacturers of LCD TV sets typically employ a structure that comprises a multi-layer front polarizer assembly, a multi-layer rear polarizer assembly, and, sandwiched between such assemblies, a liquid crystal glass cell or layer. Each polarizer assembly includes, in sequential order and operative (preferably physical, more preferably physical, laminar and bonded or adhesive) contact, an outer protective layer or film, a polyvinyl alcohol (PVA) film, which typically contains a dichromatic substance such as iodine as polarizer layer or film (front polarizer layer in the case of the front polarizer assembly and rear polarizer layer in the case of the rear polarizer assembly), and an inner protective layer or film. “Inner” and “outer” orient the protective layers relative to the liquid crystal glass cell or layer, with inner being adjacent to, preferably adjacent to and in physical or operative contact with, a surface, preferably a major surface, and, more preferably, a major planar surface of the liquid crystal glass cell or layer, and outer being disposed remote from said liquid crystal glass cell or layer.

For many of LCD devices, for example, in an in-plane switching (IPS) mode LCD TV, LCD display manufacturers desire an inner protective layer that has an optical retardation at all angles of light incidence that nears zero nm, preferably approximates zero nm, and, most preferably, equals zero nm.

Triacetyl cellulose (TAC) films constitute one class of materials that provides a near zero optical retardation, but such films tend to be moisture sensitive, with moisture absorption over time leading to dimensional stability deterioration.

Cyclic olefin polymers (“COP”) or copolymers (“COC”) yield films that have less moisture sensitivity than TAC films, but a considerably higher R₀ and Rth than such TAC films. For example, a typical COP film has a R₀ that falls within a range of from five nm to 10 nm. A typical COC film may have slightly lower retardation values than a COP film, but manufacturers consider it to be too brittle for use as a protective film in a polarizer film assembly.

United States Patent Application Publication (USPAP) 2003/0031848 (Sawada et al.) discloses an optical film made via melt extrusion of a non-crystalline thermoplastic resin such as a saturated norbornene resin and having a thickness of <100 micrometers (μm).

United States Provisional Patent Application 60/989,154, filed 20 Nov. 2007, discloses a polymeric film that has a birefringence within a range of from 0.001 to 0.05, and a R₀ within a range of from 25 nm to 500 nm at a wavelength of 633 nm.

In some embodiments, this invention is an optical film that comprises a hydrogenated vinyl aromatic/conjugated diene block copolymer, the optical film having a R₀, measured using incident light at a wavelength of 633 nm and being directed normal to a major planar surface of the film, that is <five nm and a Rth (represented by the equation (((nx+ny)/2)−nz)d) that is <10 nm. The hydrogenated vinyl aromatic/conjugated diene block copolymer is preferably a substantially fully hydrogenated vinyl aromatic/conjugated diene block copolymer, more preferably a fully hydrogenated vinyl aromatic/conjugated diene block copolymer. Alternatively, the hydrogenated vinyl aromatic/conjugated diene block copolymer is a blend of two or more of a hydrogenated vinyl aromatic/conjugated diene block copolymer, a substantially fully hydrogenated vinyl aromatic/conjugated diene block copolymer, and a fully hydrogenated vinyl aromatic/conjugated diene block copolymer.

Calculate Rth from R₀ measurements using incident light normal to a major planar surface of the film and measurements made at an oblique light incidence angle of 40 degrees) (40°. Make the oblique light incidence angle measurement by tilting the film 40° with respect to either its slow axis direction or its fast axis direction. Determine film slow axis direction or fast axis direction from R₀ measurements. The optical film may be unstretched (for example, substantially as prepared via a process that induces little, if any, mechanical orientation) or stretched, whether uniaxially, biaxially or multi-axially, via conventional technology known to those skilled in the art. The optical film is preferably an unstretched film. If stretched, the hydrogenated vinyl aromatic/conjugated diene block copolymer preferably has a crystallinity of <three wt percent, based upon total film weight.

The optical film may be used as an inner protective layer in an IPS mode, LCD device.

In some embodiments, this invention is a polarizer assembly, the polarizer assembly comprising a PVA film layer and a protective film layer, the PVA film layer having attached to at least (≧) one of its major planar surfaces, a protective film layer that comprises the above optical film. Each protective film is in operative contact, preferably in adhesive contact by way of an adhesive, with a major planar surface of the PVA film layer. If desired, one may improve adhesive bonding by treating the film via known technology such as corona treatment or plasma treatment.

The optical film optionally also comprises any optical additive (for example, a rod-like or disc-like liquid crystal molecule) currently used in TAC-based optical films. The optical film need not, however, include one or more optical additives in order to attain near zero R₀ and Rth.

When ranges are stated herein, as in a range of from 2 to 10, both end points of the range (for example, 2 and 10) and each numerical value, whether such value is a rational number or an irrational number, are included within the range unless otherwise specifically excluded.

“Comprising” and its derivatives do not exclude the presence of any additional component, step or procedure, whether or not the same is disclosed herein. In contrast, “consisting essentially of” excludes from the scope of any succeeding recitation any other component, step or procedure, excepting those that are not essential to operability. “Consisting of” excludes any component, step or procedure not specifically delineated or listed. “Or”, unless stated otherwise, refers to the listed members individually as well as in any combination.

Expressions of temperature may be in terms either of degrees Fahrenheit (° F.) together with its equivalent in ° C. or, more typically, simply in ° C.

Unless stated to the contrary, implicit from the context, or customary in the art, all parts and percents are based on weight.

For purposes of United States patent practice, the contents of any patent, patent application, or publication referenced herein are hereby incorporated by reference in their entirety (or the equivalent US version thereof is so incorporated by reference) especially with respect to the disclosure of synthetic techniques, definitions (to the extent not inconsistent with any definitions provided herein) and general knowledge in the art.

Descriptions and examples serve to illustrate, rather than define or limit, this invention in any way and do not constitute an exhaustive or all-inclusive listing of all possible embodiments of this invention.

As used herein, “near zero optical retardation” means an R₀ of less than (<) 5 nm and an Rth of <10 nm The R₀ is preferably <3 nm, more preferably <2 nm, still more preferably <1 nm, and even more preferably <0.5 nm. The Rth is preferably <5 nm, more preferably <3 nm

The optical films described herein preferably comprise a hydrogenated vinyl aromatic/conjugated diene block copolymer. The hydrogenated vinyl aromatic/conjugated diene block copolymer is more preferably substantially fully hydrogenated, and still more preferably fully hydrogenated vinyl aromatic/conjugated diene polymer. In each case, “hydrogenated” refers to hydrogenation of double bonds present in both vinyl aromatic moieties and conjugated diene moieties.

If one elects to accept a reduction in one or both of heat resistance and mechanical properties such as modulus and toughness, one may use a fully hydrogenated, random vinyl aromatic/conjugated diene copolymer in place of all or part of the preferred hydrogenated vinyl aromatic/conjugated diene block copolymer. For example, if one requires a minimum glass transition temperature (T_{g}) of 100° C., a random copolymer with such a T_{g} typically has a pre-hydrogenation vinyl aromatic (for example, styrene) content ≧85 wt percent, based upon total pre-hydrogenation random copolymer weight. Skilled artisans usually consider a film prepared from such a random copolymer to be very brittle and unsuitable for use in applications that require some flexibility necessary for film cutting and handling (for example, lamination) or an ability to conform to a non-planar surface.

The vinyl aromatic/conjugated diene block copolymer, prior to hydrogenation, may have any known architecture, including distinct block, tapered block, and radial block. Distinct block structures that include alternating vinyl aromatic blocks and conjugated diene blocks yield preferred results, especially when such block structures yield triblock copolymers or pentablock copolymers, in each case with vinyl aromatic end blocks. Pentablock copolymers constitute particularly preferred block copolymers. The vinyl aromatic blocks may have the same or different molecular weights as desired. Similarly, the conjugated diene blocks may have the same or different molecular weights.

The vinyl aromatic blocks may comprise any of the vinyl aromatic monomers taught in U.S. Pat. No. 6,632,890 (Bates et al.) and U.S. Pat. No. 6,350,820 (Hahnfeld et al. Typical vinyl aromatic monomers include styrene, alpha-methylstyrene, all isomers of vinyl toluene (especially paravinyl toluene), all isomers of ethyl styrene, propyl styrene, butyl styrene, vinyl biphenyl, vinyl naphthalene, vinyl anthracene and the like, and mixtures thereof. The block copolymers can contain one or more than one polymerized vinyl aromatic monomer in each vinyl aromatic block. The vinyl aromatic blocks preferably comprise styrene, more preferably consist essentially of styrene, and still more preferably consist of styrene.

The conjugated diene blocks may comprise any monomer that has two conjugated double bonds as taught in U.S. Pat. No. 6,632,890 and U.S. Pat. No. 6,350,820. Illustrative, but non-limiting examples of conjugated diene monomers include butadiene, 2-methyl-1,3-butadiene, 2-methyl-1,3-pentadiene, isoprene, and mixtures thereof. As with the vinyl aromatic blocks, the block copolymers may contain one (for example, butadiene or isoprene) or more than one (for example, both butadiene and isoprene). Preferred conjugated diene polymer blocks in the block copolymers may, prior to hydrogenation, comprise polybutadiene blocks, polyisoprene blocks or mixed polybutadiene/polyisoprene blocks. While a block copolymer may, prior to hydrogenation, include ≧one polybutadiene block and ≧one polyisoprene block, preferred results follow with block copolymers that, prior to hydrogenation, have conjugated diene blocks that are solely polybutadiene blocks or solely polyisoprene blocks. A preference for a single diene monomer stems primarily from manufacturing simplicity.

U.S. Pat. No. 6,350,820 defines a block as a polymeric segment of a copolymer that can exhibit microphase separation from a structurally or compositionally different polymeric segment of the copolymer. Microphase separation occurs due to incompatibility of polymeric segments within the block copolymer.

Illustrative preferred vinyl aromatic/conjugated diene block copolymers wherein each vinyl aromatic block comprises styrene (S) and each conjugated diene block comprises butadiene (B) or isoprene (I) include SBS and SIS triblock copolymers and SBSBS and SISIS pentablock copolymers. While the block copolymer may be a triblock copolymer or, more preferably a pentablock copolymer, the block copolymer may be a multiblock that has one or more additional vinyl aromatic polymer blocks, one or more additional conjugated diene polymer blocks or both one or more additional vinyl aromatic polymer blocks and one or more additional conjugated diene polymer blocks, or a star block copolymer (for example, that produced via coupling). One may use a blend of ≧two block copolymers (for example, ≧two triblock copolymers, ≧two pentablock copolymers or ≧one triblock copolymer and ≧one pentablock copolymer) if desired. One may also use ≧two different diene monomers within a single block, which would provide a structure that may be shown as, for example, SIBS. These representative structures illustrate, but do not limit, block copolymers that may be suitable for use in an embodiment of this invention. In each case, the preferred block copolymers are shown prior to hydrogenation.

“Substantially fully hydrogenated” means that ≧90 percent (percent) of double bonds present in vinyl aromatic blocks prior to hydrogenation are hydrogenated or saturated and ≧95 percent of double bonds present in diene blocks prior to hydrogenation are hydrogenated or saturated.

“Fully hydrogenated” means that ≧95 percent of the double bonds present in vinyl aromatic blocks prior to hydrogenation are hydrogenated or saturated and ≧97 percent of double bonds present in diene blocks prior to hydrogenation are hydrogenated or saturated.

Preferred hydrogenated block copolymers comprise ≧two blocks of hydrogenated, polymerized vinyl aromatic monomer and ≧one block of hydrogenated, polymerized diene monomer. Preferred hydrogenated triblock copolymers have two blocks of hydrogenated, polymerized vinyl aromatic monomer, one block of hydrogenated, polymerized diene monomer and a total number average pre-hydrogenation molecular weight (Mₙ) of from 20,000, preferably ≧30,000, more preferably ≧40,000, and still more preferably ≧50,000, to 150,000, preferably to 120,000, more preferably to 100,000 and still more preferably to 90,000. Preferred hydrogenated pentablock copolymers have three blocks of hydrogenated, polymerized vinyl aromatic monomer, two blocks of hydrogenated, polymerized diene monomer and a total Mₙ of from 30,000, preferably ≧40,000, and more preferably ≧50,000, to 200,000, preferably to 150,000, more preferably to 120,000, and still more preferably to 100,000.

The block copolymer, prior to hydrogenation, preferably prior to hydrogenation and formation into a film, is a styrene/conjugated diene monomer block copolymer) that has a styrene content within a range of from 55 wt percent to <90 wt percent, preferably from 65 wt percent to 85 wt percent, and more preferably from 65 wt percent to 80 wt percent, and a conjugated diene monomer content within a range of from 45 wt percent to ≧10 wt percent, preferably from 35 wt percent to 15 wt percent, and more preferably from 35 wt percent to 20 wt percent, each wt percent being based upon total block copolymer weight and, when taken together equal 100 wt percent.

As styrene content falls below 55 wt percent, particularly as it falls to 50 wt percent or less (≦), dimensional stability of a film prepared from such a polymer begins to lessen. The styrene content range is more preferably from 60 wt percent to <85 wt percent and still more preferably from 65 wt percent to <80 wt percent. Conversely, the conjugated diene monomer content range is more preferably from 40 wt percent to ≧15 wt percent and still more preferably from 35 wt percent to ≧20 wt percent.

Selection of diene monomer for a hydrogenated vinyl aromatic/conjugated diene block copolymer affects both whether crystallinity exists and, if it exists, extent of crystallinity. For example, hydrogenated polyisoprene has an alternating poly(ethylene-alt-propylene) repeat unit structure, which exhibits no discernible, at least by current technology, crystallinity. Hydrogenated polybutadiene has a poly(ethylene-co-1-butene) repeat unit structure that can exhibit crystallinity due to the polyethylene component. Crystallinity levels attainable in a hydrogenated polybutadiene block depend, at least in part, on polymer microstructure, that is, percentage of butadiene monomer incorporated in such microstructure via 1,2-polymerization versus incorporation via 1,4-polymerization. As percentage of incorporated butadiene monomer via 1,2-polymerization exceeds 30 wt percent, crystallinity evident in a hydrogenated polybutadiene block begins to diminish. Similarly, a hydrogenated block copolymer that has a diene block that comprises a blend of isoprene and butadiene monomers prior to hydrogenation also has a crystallinity intermediate between zero and that delivered by a pure hydrogenated polybutadiene component.

The vinyl aromatic/conjugated diene block copolymer preferably has a crystallinity of <three weight percent (wt percent), with a crystallinity of <1 wt percent being more preferred and a crystallinity of <0.5 wt percent being still more preferred. Determine percent crystallinity via differential scanning calorimetry (DSC).

A crystallinity of zero does not, however, equate to an in-plane optical retardation (R₀) of 0 due, at least in part, to birefringence resulting from, for example, anisotropic polymer chain orientation during fabrication and/or block copolymer morphology that exists in a fabricated article.

One may also blend a non-block polymer or copolymer with ≧one block copolymer such that an optical film further comprises an amount of a non-block polymer or copolymer. Illustrative non-block polymers and copolymers include, but are not limited to, hydrogenated vinyl aromatic homopolymers or random copolymers, polyolefins, cyclo olefin polymers, cyclo olefin copolymers, acrylic polymers, acrylic copolymers and mixtures thereof. The non-block polymer or copolymer, when blended with a block copolymer, is miscible with, and sequestered within, ≧one phase of the block copolymer. The amount of non-block polymer preferably falls within a range of from 0.5 wt percent to 50 wt percent, based upon combined weight of block copolymer and non-block copolymer. The range is more preferably from 1 wt percent to 40 wt percent and still more preferably from 5 wt percent to 30 wt percent.

Additional illustrative non-block copolymers include a polymer (for example, a homopolymer, a random copolymer or an interpolymer) selected from a group consisting of vinyl aromatic homopolymers and hydrogenated random copolymers of a vinyl aromatic monomer and a conjugated diene.

“Homopolymer” refers to a polymer having polymerized therein a single monomer (for example, styrene monomer in a polystyrene homopolymer). Similarly, “copolymer” refers to a polymer having polymerized therein two different monomers (for example, styrene monomer and acrylonitrile monomer in a styrene acrylonitrile copolymer) and “interpolymer” refers to a polymer having polymerized therein three or more different monomers (for example, ethylene monomer, propylene monomer and a diene monomer in an ethylene/propylene/diene monomer (EPDM) interpolymer).

The optical films described herein have utility as a protective film for a polarizer assembly, especially for a polarizer assembly used in IPS mode LCD TV sets or any other imaging device that requires polarizer film stacks with near zero optical retardation over a range of light incidence angles (for example, from normal to the film up to nearly 90° greater than (>) or less than (<) normal). Such films also find use as a protective film in quarter wave plates used in reflective and trans-reflective LCD displays. Such films further find use as any one or more of a) a base film substrate or layer for an anti-glare film or an anti-reflective film, b) a base film substrate or layer for a linear polarizer or a circular polarizer film, or c) a touch screen film.

The optical films described herein may be single or monolayer films or may constitute one or more layers of a multi-layer film structure. The optical films have two spaced apart and preferably substantially parallel major surfaces. The optical films may, if desired, include ≧one conventional additive such as an antioxidant, an ultraviolet (UV) light stabilizer, a plasticizer, a release agent, an anti-static agent, or any other conventional additive used in fabricating polymeric films.

The optical film may be at least partially cross-linked using conventional cross-linking additives (for example, siloxane) and a conventional cross-linking mechanism, including use of ultraviolet light, moisture or heat to initiate cross-linking Cross-linking may occur post-film extrusion. In any event, a level of cross-linking may be beneficial as long as it does not lead to formation of gels that interfere with, among other optical film features or properties, film clarity or transparency.

Compositions used to make the optical films also have utility in fabricating other articles of manufacture that benefit from low optical retardation including, but not limited to, high density digital video discs and optical pick up lenses. Skilled artisans recognize that disc or lens molding, which involves a fabrication method that differs from film extrusion, may lead, in turn, to a different set of optical parameters and physical property performance requirements.

The optical films preferably result from a melt extrusion or melt casting procedures such as those taught in Plastics Engineering Handbook of the Society of Plastics Industry, Inc., Fourth Edition, pages 156, 174, 180 and 183 (1976). Typical melt casting procedures include use of a melt extruder, such as a mini-cast film line manufactured by Killion Extruders, Inc., operating with set point temperatures, extruder screw speed, extruder die gap settings and extruder back pressure sufficient to convert a polymer or blend of polymers from a solid (for example, granular or pellet) state to a melt state or molten polymer. Use of a conventional film forming die, such as a “T-die” disclosed in U.S. Pat. No. 6,965,003 (Sone et al.) or a “coat hanger die” disclosed in Modern Plastics Handbook, Edited by Modern Plastics; Charles A Harper. (McGraw-Hill, 2000), Chapter 5, Processing of Thermoplastics, page 64-66, yields a film meeting physical property and performance parameters noted hereinabove.

Prepare the above optical films via known film manufacturing techniques, especially extrusion casting or extrusion calendering, but also including other techniques such as solution casting. For extrusion casting, a suitable melt processing ranges from a hydrogenated vinyl aromatic/conjugated diene block polymer's order-to-disorder temperature (T_{ODT}), when there is an T_{ODT}, to <310 degrees centigrade (° C.) or from 180° C. to <310° C., preferably from 200° C. to 280° C., when there is no measurable T_{ODT}.

In some cases, the T_{ODT} of a hydrogenated vinyl aromatic-conjugated diene block copolymer of this invention is lower than its T_{g} and thus inaccessible. A preferred melt processing window allows one to extrude a polymer melt at a temperature higher than (>) Tg+30° C. but <310° C., more preferably >Tg+50° C. but ≦280° C. In other cases, the T_{ODT} of a hydrogenated vinyl aromatic-conjugated diene block copolymer may be too high (>310° C.), such copolymer being very difficult to fabricate into a film or sheet by melt extrusion and thus not suitable for some embodiments of this invention. For a hydrogenated vinyl aromatic-conjugated diene block copolymer with an accessible T_{ODT}, that is, >Tg but <310° C., a suitable melt extrusion temperature for the preparation of a low retardation optical film is a melt temperature >T_{ODT} but <310° C., more preferably >T_{ODT}+20° C. but <310° C., even more preferably >T_{ODT}+50° C. but <310° C.

“T_{ODT}” means a temperature at which a block copolymer loses discrete, periodic morphological order and transitions to a substantially homogeneous melt of chains. A small angle X-ray scattering (SAXS) image of a hydrogenated block copolymer in its ordered state is highly anisotropic. Anisotropy is most evident when a polymer melt is shear aligned at a temperature below its T_{ODT} under a low frequency (for example, a frequency of 0.01 radians per second (rad/s) to 0.1 rad/s) and a large strain amplitude oscillatory shear (for example, a strain amplitude of 100 percent to 300 percent). Shear alignment behavior of a microphase separated block copolymer is well known and may be found, for example, in The Physics of Block Copolymers by Ian Hamley, Oxford University Press, 1998. Conversely, a SAXS image of a hydrogenated block copolymer in a disordered state shows no detectable amount of anisotropy, because individual polymer chains start to assume a random coil configuration. When polymer melt temperature exceeds a polymer's T_{ODT}, a cast film from such a polymer melt tends to be very transparent and have very low haze. When the polymer melt temperature falls well below a polymer's T_{ODT} (for example, >30° C. below the T_{ODT}), optical transparency of a cast film can be influenced by fabrication conditions. In some cases, such a film may appear to be slightly hazy, possibly due to microscale roughness on the film surface. In the latter case, a subsequent film orientation/stretching step (either biaxial or uniaxial) at a temperature above the polymer's glass transition temperature (T_{g}) may be employed to improve the transparency of such films.

Ian Hamley discusses T_{ODT} measurements in The Physics of Block Copolymers, pages 29-32, Oxford University Press, 1998, the teachings of which are incorporated herein to the maximum extent permitted by law.

An “unstretched” (or “unoriented”) film means a film made by extrusion casting (or calendaring) and used as is. Preparation of such films does not involve a separate processing step of orientating a film by stretching it under heat (for example, at a temperature at or above the glass transition temperature of the polymer used to make the film). Skilled artisans recognize that some degree of orientation inevitably occurs in a cast film during one or both film casting itself and winding of a cast film into a roll for further processing. This invention excludes such inevitable degree of orientation from its definition of “orientation” or “oriented”.

Conversely, preparation of a “stretched” (or “oriented”) film does include a separate processing step that follows preparation of a film made by extrusion casting (or calendaring). The separate processing step involves orienting or stretching a film, either uniaxially or biaxially, at a temperature at or above the glass transition temperature of the polymer used to make the film. For more information on well-known methods of film orientation or film stretching, see, for example, a monograph entitled “Plastic Films” by John H. Briston, Chapter 8, page 87-89, Longman Scientific & Technical (1988).

While melt extrusion represents a preferred means or process of fabricating films of this invention, one may use other, less preferred techniques if desired. For example, one may use solvent casting, recognizing that solvent handling and solvent removal pose additional challenges, including environmental challenges. One may also prepare films via pressed film procedures.

For extrusion casting, a cast roll or chill roll temperature of <110° C. yields satisfactory results. The cast or chill roll temperature is preferably <100° C., and more preferably <95° C. A practical lower limit for cast or chill roll temperature is 40° C.

The optical films have a thickness that is preferably <250 micrometers (μm), more preferably ≦150 μm, and still more preferably ≦100 μm. A practical lower limit for film thickness is 15 μm, with 25 nm being a preferred lower limit for film thickness.

Once prepared, an optical film may be subjected to one or more post-processing operations. For example, a film may be annealed at a temperature within a range of from the hydrogenated vinyl aromatic/conjugated diene block copolymer's melt temperature (Tₘ), if it has a measurable melt temperature, to its T_{g} to improve one or more of its optical and mechanical properties. An illustrative annealing temperature range is from 70° C. to 100° C. As an alternate to annealing, a film may be oriented or stretched in ≧one direction (for example, its machine direction (MD) and/or its transverse direction (TD)) at a temperature within a range of from the hydrogenated vinyl aromatic/conjugated diene block copolymer's T_{g}−10° C. to its T_{g}+75° C. The range is preferably from Tg to Tg+50° C.

### EXAMPLES

The following examples illustrate, but do not limit, this invention. All temperatures are in ° C. Examples (Ex) of the present invention are designated by Arabic numerals and Comparative Examples (Comp Ex or CEx) are designated by capital alphabetic letters. Unless otherwise stated herein, “room temperature” or “ambient temperature” is nominally 25° C.

Determine T_{ODT} of hydrogenated styrenic block copolymers by first compression molding, at a temperature of 230° C., an aliquot of the copolymer into a circular, disk-shaped specimen having a diameter of 25 millimeters (mm) and a thickness of 1.5 mm. Subject the specimens to dynamic rheological characterization in a linear viscoelastic regime to find a discontinuity in low frequency elastic modulus during a ramp up in heating at a rate of 0.5° C. per minute over a temperature range of from 160° C. to 300° C. using a parallel plate rheometer (ARES rheometer, TA Instruments, New Castle, Del.) operating at an oscillatory frequency of 0.1 radians per second (rad/sec) and a strain amplitude of one percent. Prior to the dynamic rheological measurement, thermally equilibrate the specimen at 160° C. for 30 minutes. T_{ODT} determinations made in this manner have an accuracy of ±5° C.

Measure optical retardation of a film sample using an EXICOR™ 150ATS (Hinds Instrument) apparatus and a wavelength of 633 nanometers (nm) by selecting a rectangular section (30 millimeters (mm) in the MD by 100 mm in the TD) of film from a portion of the film that includes no apparent visual defects and making ≧120 independent measurements of optical retardation over different regions of the rectangular section. Each measurement represents a film area measuring 5 mm by 5 mm Measure R₀ when incident light is normal to a major planar surface of the rectangular film section. Report in-plane retardation (R₀) as an average of the ≧120 independent measurements and calculate standard deviation of R₀ based upon all independent measurements made on that section of film. Calculate Rth as described above. Report Rth of a film as an average over five independent measurements from a portion of the film that includes no apparent visual defects. Make the oblique light incidence angle measurement R₄₀ by tilting the film 40° with respect to either its slow axis direction or its fast axis direction. Determine the film slow axis direction or fast axis direction from R₀ measurements. If one assumes that the film slow axis direction is its x-axis and that the x-axis is also the tilting axis for R₄₀ measurements, one can calculate Rth by solving (nₓ, n_{y}, n_{z}) values from the following three equations:

$${n}_{x} + {n}_{y} + {n}_{z} = 3 {n}_{0} \\ ( {n}_{x} - {n}_{y} ) \times d = {R}_{0} \\ ( {n}_{x} - \frac{{n}_{y} {n}_{z}}{\sqrt{{n}_{z}^{2} {cos}^{2} θ + {n}_{y}^{2} {sin}^{2} θ}} ) \times \frac{d}{cos θ} = {R}_{40}$$

In the above three equations, n₀ is the refractive index of the polymer used to make the film (measured by a multi-wavelength Abbe refractometer DR-M2, manufactured by ATAGO Co., Ltd.), d represents film thickness, and angle θ is determined by the following equation:

$$sin θ = \frac{sin 40 °}{{n}_{0}}$$

Based upon solutions from the above three equations and d, calculate Rth as follows:

$$Rth = ( \frac{{n}_{x} + {n}_{y}}{2} - {n}_{z} ) \times d$$

Use DSC analysis and a model Q1000 DSC (TA Instruments, Inc.) to determine wt percent of crystallinity (X percent) with respect to the total weight of a hydrogenated styrenic block copolymer or film sample. General principles of DSC measurements and applications of DSC to studying semi-crystalline polymers are described in standard texts (for example, E. A. Turi, ed., Thermal Characterization of Polymeric Materials, Academic Press, 1981).

Calibrate the model Q1000 DSC first with indium and then with water in accord with standard procedures recommended for the Q1000 to ensure that heat of fusion (H_{f}) and onset of melting temperature for indium are within, respectively, 0.5 joules per gram (J/g) and 0.5° C. of prescribed standards (28.71 J/g and 156.6° C.) and that onset of melting temperature for water is within 0.5° C. of 0° C.

Press polymer samples into a thin film at a temperature of 230° C. Place a piece of the thin film that has a weight of from 5 milligrams (mg) to 8 mg in the DSC sample pan. Crimp a lid on the pan to ensure a closed atmosphere.

Place the sample pan in the DSC's cell and heat contents of the pan at a rate of about 100° C./min to a temperature of 230° C. Maintain contents of the pan at that temperature for approximately three minutes, then cool the pan contents at a rate of 10° C./min to a temperature of −60° C. Keep the pan contents isothermally at −60° C. for three minutes and then heat the contents at a rate of 10° C./min up to 230° C. in a step designated as the “second heating”.

Analyze enthalpy curves that result from the second heating of polymer film samples as described above for peak melt temperature, onset and peak crystallization temperatures, and H_{f} (also known as heat of melting). Measure H_{f} in units of J/g by integrating the area under the melting endotherm from the beginning of melting to the end of melting by using a linear baseline.

A 100 percent crystalline polyethylene has an art-recognized H_{f} of 292 J/g. Calculate wt percent of crystallinity (X percent) with respect to the total weight of a hydrogenated styrene block copolymer or film sample by using the following equation:

X percent=(H_{f}/292)×100 percent

Conduct molecular weight analysis of a hydrogenated vinyl aromatic-conjugated diene block copolymer by subjecting the block copolymer, prior to its hydrogenation, to gel permeation chromatography (GPC) using tetrahydrofuran (THF) as a solvent for the block copolymer. Calibrate GPC columns using narrow molecular weight polystyrene standards from Polymer Labs, Inc. The molecular weight of the standards ranges from 580 Daltons to 3,900,000 Daltons. Report Mn or weight average molecular weight (M_{w}) of pre-hydrogenated block copolymers as polystyrene-equivalent values.

Perform GPC analysis of fully hydrogenated vinyl aromatic-conjugated diene block copolymers that have no crystallinity or only a low amount of crystallinity by first dissolving a sample of such a hydrogenated block using a dual solvent (Decalin/THF, where Decalin is shorthand for decahydronaphthalene (C₁₀H₁₈)) to form a polymer solution and then analyzing the polymer solution using a conventional GPC system (for example, Hewlet Packard HP 1090) by running THF as a mobile phase at 40° C. Similarly, report Mn or weight average molecular weight (M_{w}) of fully hydrogenated block copolymers as polystyrene-equivalent values.

Table 1 below summarizes hydrogenated styrenic block copolymer materials and other materials used in succeeding Ex and Comp Ex. Comp Ex A is a cyclic olefin polymer (COP) film commercially available from Nippon Zeon under the trade designation ZEONOR™ ZF-14 film. In Table 1, show 1,2-vinyl content (also known as 1,2-butadiene or 1,2-isoprene content) as a percentage relative to total conjugated diene content present in a polymer prior to hydrogenation. In Table 1, Mₙ refers to polystyrene-equivalent molecular weight based upon GPC analysis as described above using tetrahydrofuran (THF) as a solvent. For all materials other than A and E, Mₙ values reflect polymer properties prior to hydrogenation. Materials A and E have Mₙ determinations made on fully hydrogenated polymers via GPC analysis using a dual solvent as detailed above. Material A has an unexpected low amount of crystallinity as pure hydrogenated polyisoprene should have no crystallinity.

TABLE 1

| | | | | Pre- | | | |
|---|---|---|---|---|---|---|---|
| | | | | hydro- | | | |
| | | | | genation | Nominal | | |
| | | | | Styrene | 1,2-vinyl | | |
| Material | Polymer | | | Content | Content | | T_{ODT} |
| Code | Structure | Diene | Mₙ | (wt %) | (%) | X % | (° C.) |
| A | Pentablock | I | 71,000* | 70 | 8 | 0.2 | <200 |
| B | Pentablock | B | 63,500 | 90 | 8 | 0 | <200 |
| C | Pentablock | B | 75,000 | 85 | 11 | 2.4 | <200 |
| D | Pentablock | B | 67,000 | 80 | 8 | 2.8 | nd |
| E | Pentablock | I | 64,000* | 70 | 10 | 0 | <200 |
| F** | Pentablock | B | 75,000 | 70 | 9 | 7.0 | 240 |
| G** | Pentablock | B | 60,000 | 60 | 11 | 7.4 | 225 |
| H** | Triblock | B | 53,000 | 50 | 40 | nd | nd |

“nd” means not determined
*Mn determinations based upon post (fully hydrogenated) polymer rather than prehydrogenated polymer
**means resins or materials used to make comparative examples

### Ex 1-Ex 16 and Comp Ex A through Comp Ex I

Prepare unstretched monolayer polymeric film material samples using a hydrogenated styrene/conjugated diene block copolymer selected from Table 1 above and a mini-cast film line manufactured by Killion Extruders, Inc. The film line includes a 25 mm extruder that has a length to diameter (L/D) ratio of 24:1 and operates at a set point extrusion temperature as shown in Table 2 below. The extruder cooperates with a coat hanger extrusion die (10 inches (25.4 cm) wide with a die gap set at 0.040 inch (1 mm) The die operates at a set point temperature within a range of from 200° C. to 290° C. The film line also includes a casting roll that has a ceramic coating, a diameter of 8 inches (20.3 cm) and a width of 12 inches (30.5 cm), and operates at a set point temperature within a range of from 85° C. to 90° C. Keep extruder output constant at about 5 pounds per hour (11 kg per hour) and vary cast roll speed based upon film gauge (40 μm, 60 μm, 80 μm or 130 μm) being produced. Table 2 also shows film gauge, R₀ and Rth for each different film sample.

TABLE 2

| Ex/ | | Extrusion | Film | | |
|---|---|---|---|---|---|
| Comp | | Temp | Gauge | R₀ | Rth |
| Ex | Material | (° C.) | (μm) | (nm) | (nm) |
| 1 | A | 250 | 40 | 0.3 | 0.4 |
| 2 | A | 250 | 60 | 0.6 | 0.4 |
| 3 | A | 250 | 80 | 0.9 | 0.4 |
| 4 | A | 280 | 40 | 0.5 | 0.4 |
| 5 | A | 280 | 60 | 0.7 | 1 |
| 6 | A | 280 | 80 | 0.9 | 1.5 |
| 7 | A | 220 | 40 | 3.4 | 3.2 |
| 8 | A | 220 | 60 | 3.6 | 3.6 |
| 9 | A | 220 | 80 | 3.5 | 3.7 |
| 10 | B | 220 | 40 | 2 | 3.1 |
| 11 | B | 220 | 60 | 2.4 | 3.3 |
| 12 | B | 220 | 80 | 2.6 | 3.7 |
| 13 | C | 250 | 40 | 2.6 | 1.4 |
| 14 | C | 250 | 60 | 3.1 | 7.5 |
| 15 | D | 250 | 40 | 1.9 | 1.5 |
| 16 | D | 250 | 60 | 4.2 | 5.65 |
| A | COP | N/A | N/A | 5.9 | ND |
| B | B | 200 | 60 | 9.6 | ND |
| C | C | 220 | 60 | 31.2 | ND |
| D | D | 220 | 60 | 14.8 | ND |
| E | C | 250 | 80 | 5.7 | ND |
| F | D | 250 | 80 | 7 | ND |
| G | F | 250 | 50 | 148.5 | ND |
| H | G | 250 | 50 | 32.1 | ND |
| I | H | 250 | * | * | * |

ND means not determined;
* means the film was too tacky or sticky to provide useful measurements

The data presented in Table 2 above support several observations. First, Ex 1-6 demonstrate that one can prepare optical films that have very low R₀ (less than 1 nm) and Rth (less than 2 nm) over ≧a 30° C. melt processing temperature window of from 250° C. to 280° C. and in a range of thicknesses with a hydrogenated SISIS pentablock copolymer that has a styrene content of 70 wt percent. Second, Ex 7-16 and Comp Ex B through Comp Ex F show that processing temperature plays an important part in preparing optical films from a variety of hydrogenated pentablock copolymers (SISIS for Ex 7-9 and SBSBS for Ex 10-16 and Comp Ex B through Comp Ex F) with varying Mn values and styrene contents that range from 70 wt percent to 90 wt percent. When the melt processing or extrusion temperature is less than an optimal melt processing temperature (for example, below the 30° C. melt processing temperature window noted above), as in Ex 7-16, resulting cast films appear to have some degree of molecular orientation which leads, in turn, to an appreciably higher level of optical retardation than that of Ex 1-6 (for example, an R₀ of 3.4 for Ex 7 versus an R₀ 0.29 for Ex 1). Third, Comp Ex B through Comp Ex F show that polymer composition (that is styrene content and crystallinity) and film thickness have an effect upon optical retardation performance, especially R₀. Comp Ex G and Comp Ex H suggest that even with a pentablock SBSBS structure, excessive crystallinity (for example, greater than or equal (≧) to 7.0 percent) adversely affects R₀ and makes use of such pentablock SBSBS structures unsuitable for use in end use applications that require near zero R₀ and Rth values, irrespective of melt processing temperature used for film extrusion. Fourth, Comp Ex I shows that excessively low styrene content (in this case 50 wt percent, based upon total pre-hydrogenation polymer weight) yields a hydrogenated polymer that is too soft and sticky for use as an optical film in applications that require near zero R₀ and Rth values. Fifth, Comp Ex A shows that a COP film does not have near zero R₀ as its R₀ is 5.9 while Ex 1-6 have R₀ values less than 1 nm.

### Ex 17-19 and Comp Ex J-K

Replicate Ex 1, but initiate orientation using a draw ratio as shown in Table 3 below, a stretching temperature of 145° C. for all but Comp Ex K which has a stretching temperature of 150° C., biaxial stretching for Ex 17, Ex 18 and Comp Ex K and uniaxial (machine direction) stretching for Ex 19 and Comp Ex J. Table 3 also shows unstretched film properties and stretched film properties. Comp Ex K is the same film as used in Comp Ex A, both unstretched (same as Comp Ex A) and stretched as shown in Table 3. Ex 17 and Comp Ex J use Material E, and Ex 18 and Ex 19 use Material B, both of which are shown in Table 1 above.

TABLE 3

| | Unstretched Film | | | Film | Stretched Film | |
|---|---|---|---|---|---|---|
| Ex/ | Properties | | | Stretching | Properties | |
| Comp | Thickness | R₀ | Rth | Draw | R₀ | Rₜₕ |
| Ex | (μm) | (nm) | (nm) | Ratio | (nm) | (nm) |
| 17 | 130 | 0.99 | 0.86 | 1.5 | 3.4 | 4.5 |
| 18 | 80 | 2.56 | 3.7 | 1.3 | 4.3 | 4.2 |
| 19 | 80 | 2.56 | 3.7 | 1.3 | 4.8 | 7.1 |
| J | 130 | 0.99 | 0.86 | 1.5 | 11.4 | >10 |
| K | 130 | 5.93 | nd | 1.3 | 27.3 | >10 |

nd means not determined

The data presented in Table 3 show that film orientation, whether uniaxial or biaxial, leads to an increase in both R₀ and Rth. The data for Ex 17 and Comp Ex J suggest that uniaxial stretching (Comp Ex J) provokes a greater increase in R₀ and Rth than biaxial stretching (Ex 17), in each case relative to unstretched film properties. The data for Ex 18 and Ex 19 show that biaxial stretching has a somewhat lower increase in R₀ and Rth than uniaxial stretching for Material B, with the increase in each instance being comparable to that for Ex 17 and far less than the increase noted for Comp Ex J. A possible explanation for different responses to stretching between Material B and Material E is that Material B has a higher pre-hydrogenation styrene content and a less distinct block copolymer morphology than Material E, one or both of which leads to a correspondingly lower tendency toward orientation-induced birefringence. Comp Ex K shows than a stretched COP film is even less favorable for low retardation optical film application than the same COP film prior to stretching.

1. An optical film, the film comprising a hydrogenated vinyl aromatic/conjugated diene block copolymer and having an in-plane optical retardation (R₀), measured using incident light at a wavelength of 633 nanometers and being directed normal to a major planar surface of the film, that is less than five nanometers and an out-of-plane optical retardation (Rth) that is less than ten nanometers, the block copolymer, prior to hydrogenation, having a distinct block structure that includes alternating vinyl aromatic blocks and conjugated diene blocks, a styrene content within a range of from 55 percent by weight to less than 90 percent by weight and a conjugated diene content within a range of from 45 percent by weight to 10 percent by weight, each percentage being based upon total block copolymer weight and, when taken together equal 100 percent by weight, the hydrogenated block copolymer having a crystallinity of less than 3 weight percent, based upon total film weight.

2. The optical film of claim 1, wherein the hydrogenated vinyl aromatic/conjugated diene block copolymer is a substantially fully hydrogenated block copolymer.

3. The optical film of claim 1, wherein the hydrogenated vinyl aromatic/conjugated diene block copolymer is a fully hydrogenated block copolymer.

4. The optical film of claim 1, wherein the film is a uniaxially stretched film or a biaxially stretched film.

5. (canceled)

6. (canceled)

7. The optical film of claim 1, wherein the block copolymer is a vinyl aromatic/conjugated diene monomer triblock copolymer that has a number average molecular weight within a range of from 20,000 to 150,000.

8. The optical film of claim 1, wherein the block copolymer is a vinyl aromatic/conjugated diene monomer pentablock copolymer that has a number average molecular weight within a range of from 30,000 to 200,000.

9. The optical film of claim 1, wherein the film is a monolayer film.

10. The optical film of claim 1, wherein the film is at least one layer of a multilayer film.

11. The optical film of claim 1, wherein the film further comprises an amount of a non-block copolymer that is within a range of from 0.5 percent by weight to 50 percent by weight, based upon combined weight of block copolymer and non-block copolymer.

12. An image display device or apparatus comprising the optical film of claim 1.

13. An in-plane switching mode, liquid crystal display (LCD) device, the device comprising an inner protective layer that comprises the optical film of claim 1.

14. A polarizer assembly, the polarizer assembly comprising a polyvinyl alcohol film layer and a protective film layer, the polyvinyl alcohol film layer having at least one of its major planar surfaces in operative contact with a protective film layer, each protective film layer comprising the optical film of claim 1.
